(19) United States
(12) Patent Application Publication
(10) Pub. No.: US 2025/0263589 A1
(43) Pub. Date: Aug. 21, 2025

(54) Aqueous Adhesive Composition

(71) Applicant: SEIKO EPSON CORPORATION, Tokyo (JP)

(72) Inventors: Soichi YAMAZAKI, Shiojiri (JP); Nikako TSUKIJI, Matsumoto (JP); Harunobu KOMATSU, Matsumoto (JP)

(21) Appl. No.: 19/056,934

(22) Filed: Feb. 19, 2025

(30) Foreign Application Priority Data
Feb. 20, 2024 (JP) 2024-023864

(51) Int. Cl. C09J 133/12; B41J 3/407; B41J 11/00; B41J 29/17; C08F 8/44; C08F 220/18; C09J 5/00

(52) U.S. Cl. CPC C09J 133/12; B41J 3/4078; B41J 11/0015; B41J 29/17; C08F 8/44; C08F 220/1804; C09J 5/00; C09J 2433/00

(57) ABSTRACT

An aqueous adhesive composition to form an adhesive layer on a surface of a cloth transport member of an ink jet printing apparatus, includes a (meth)acrylic-based resin, a pH adjuster, and water. In the aqueous adhesive composition described above, the (meth)acrylic-based resin includes, as constituent units, at least four types of (meth)acrylate units A and at least one type of (meth)acrylic acid unit B, the (meth)acrylic-based resin has a glass transition temperature of −25° C. to −8° C., and a difference in glass transition temperature between the maximum value and the minimum value among homopolymers formed from the respective constituent units is 170° C. or more.

The present application is based on, and claims priority from JP Application Serial Number 2024-023864, filed Feb. 20, 2024, the disclosure of which is hereby incorporated by reference herein in its entirety.

### BACKGROUND

### 1. Technical Field

The present disclosure relates to an aqueous adhesive composition.

### 2. Related Art

Since being able to record a highly fine image using a relatively simple apparatus, an ink jet recording method has been rapidly developed in various types of fields. Among the developments, various types of studies on an ejection stability and the like have been carried out. For example, as a printing technique using an ink jet method, in order to stabilize a contact state between a removing member and a transport member and in order to improve recovery performance of washing water by the removing member, JP-A-2020-109036 has disclosed a transport device including a displacement suppression member with respect to the transport member, and an image recording apparatus.

As disclosed in JP-A-2020-109036, in the printing technique using an ink jet method, a cloth is adhered to a transport member, such as an endless belt, and is then transported to a printing portion. An adhesive is applied on a surface of the transport member, and hence, the surface of the transport member has an adhesiveness. The adhesive is also called a “temporary fixing adhesive (jibari agent)”.

The cloth to be used as a recording medium is peeled away from the transport member after printing is performed and is then transported to the following step. On the other hand, since a new cloth is again to be adhered to the transport member from which the cloth is already peeled away, inks, lint, and other remaining materials adhered to the transport member in a printing step are required to be removed. In general, the remaining materials and the like adhered to the transport member are washed out with water. In the case described above, a brush, a sponge, or the like may be used to wash the transport member in some cases.

As the adhesive used for the ink jet printing as described above, in order to have a resistance against water washing, in general, an adhesive prepared by dissolving a hydrophobic resin in an organic solvent has been used. Incidentally, in recent years, in order to reduce environmental loads and to improve working conditions, an aqueous adhesive in which usage of organic solvents is decreased has been required. However, since the aqueous adhesive is inferior in terms of durability and water resistance, the adhesiveness of the adhesive provided on the surface of the transport member tends to be gradually decreased by repeated washings, and hence, after every predetermined number of washings, a new adhesive is also required to be applied to the surface described above.

In addition, the adhesive to be used for the ink jet printing is required to maintain the adhesiveness in a wider temperature range and is also required to improve the durability and the water resistance.

### SUMMARY

According to an aspect of the present disclosure, there is provided an aqueous adhesive composition to form an adhesive layer on a surface of a cloth transport member of an ink jet printing apparatus, the aqueous adhesive composition comprising a (meth)acrylic-based resin, a pH adjuster, and water. In the aqueous adhesive composition described above, the (meth)acrylic-based resin includes, as constituent units, at least four types of (meth)acrylate units A and at least one type of (meth)acrylic acid unit B, the (meth)acrylic-based resin has a glass transition temperature of −25° C. to −8° C., and a difference in glass transition temperature between the maximum value and the minimum value among homopolymers formed from the respective constituent units is 170° C. or more.

According to another aspect of the present disclosure, there is provided an adhesiveness imparting method comprising a step of adhering the aqueous adhesive composition described above to a surface of a cloth transport member of an ink jet printing apparatus to form an adhesive layer.

According to another aspect of the present disclosure, there is provided an ink jet printing apparatus comprising a transport mechanism in which a cloth is adhered to an adhesive layer and is transported, the adhesive layer being formed of the aqueous adhesive composition described above and being provided on a surface of a cloth transport member; a recording portion to perform printing recording using an ink jet head on the cloth adhered to the adhesive layer; and a washing portion to wash the adhesive layer from which the cloth is peeled away after the printing recording is performed.

According to another aspect of the present disclosure, there is provided a cloth transport member of an ink jet printing apparatus having a surface on which an adhesive layer derived from the aqueous adhesive composition described above is provided.

According to another aspect of the present disclosure, there is provided an ink jet printing method comprising a transport step in which a cloth is adhered to an adhesive layer and is transported, the adhesive layer being formed from the aqueous adhesive composition described above and being provided on a surface of a cloth transport member of an ink jet printing apparatus; a recording step of performing printing recording using an ink jet head on the cloth adhered to the adhesive layer; and after the printing recording is performed, a washing step of washing the adhesive layer from which the cloth is peeled away.

### BRIEF DESCRIPTION OF THE DRAWINGS

FIG. 1 is a schematic cross-sectional view of an ink jet printing apparatus.

FIG. 2 is a table showing Examples and Comparative Examples.

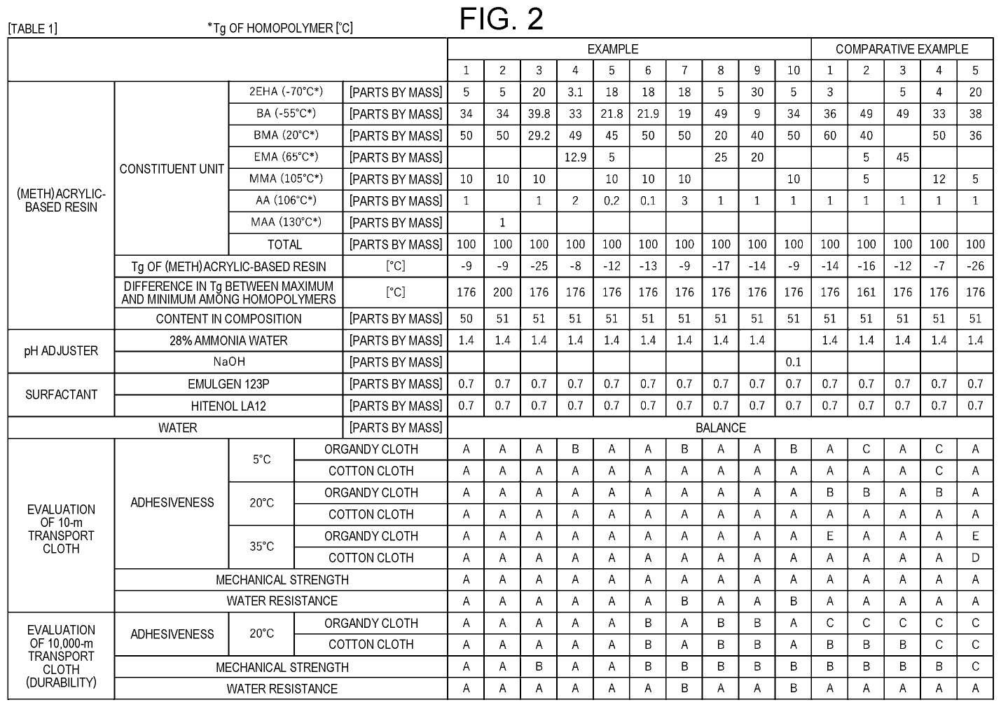

### DESCRIPTION OF EMBODIMENTS

Hereinafter, if needed, with reference to the drawings, although embodiments (hereinafter, each referred to as “this embodiment”) of the present disclosure will be described in detail, the present disclosure is not limited thereto and may be variously changed and/or modified without departing from the scope of the present disclosure. In the drawings, the same elements are designated by the same reference numerals, and duplicated descriptions will be omitted. In addition, unless otherwise particularly noted, the top to bottom and the left to right positional relationships are based on the positional relationships shown in the drawing. Furthermore, the dimensional rate shown in the drawing is not limited to that shown therein.

In addition, “(meth)acrylate” comprehensively indicates acrylate and methacrylate. In addition, the “unit” of “constituent unit” or “(meth)acrylate unit” indicates a repeating unit derived from a monomer to be polymerized into a polymer.

### 1. Aqueous Adhesive Composition

An aqueous adhesive composition according to this embodiment is a composition to form an adhesive layer on a surface of a cloth transport member of an ink jet printing apparatus and contains a (meth)acrylic-based resin, a pH adjuster, and water. In the aqueous adhesive composition described above, the (meth)acrylic-based resin includes, as constituent units, at least four types of (meth)acrylate units A and at least one type of (meth)acrylic acid unit B, the (meth)acrylic-based resin has a glass transition temperature of −25° C. to −8° C., and a difference in glass transition temperature between the maximum value and the minimum value among homopolymers formed from the respective constituent units is 170° C. or more.

In this specification, the “cloth” indicates fibers, for example, in the form of woven fabric, knitted fabric, or non-woven cloth. In a related ink jet printing apparatus, an adhesive layer is formed on a transport member, such as an endless belt, and a cloth functioning as a recording medium is adhered to the adhesive layer. Subsequently, after the cloth is transported to a printing portion, and recording is then performed on the cloth, the transport member and the cloth are peeled away from each other.

As an adhesive used for the cloth transport member as described above, in the past, a solvent-based acrylic adhesive has been frequently used. However, when the solvent-based acrylic adhesive is applied, an organic solvent contained therein is evaporated, and hence adverse influences on human bodies in working conditions have been concerned. In addition, when the solvent-based acrylic adhesive is used, an exhaust device is required to be installed in use environment of the ink jet printing apparatus, and as a result, the total apparatus configuration is inevitably enlarged, and the cost thereof is also increased.

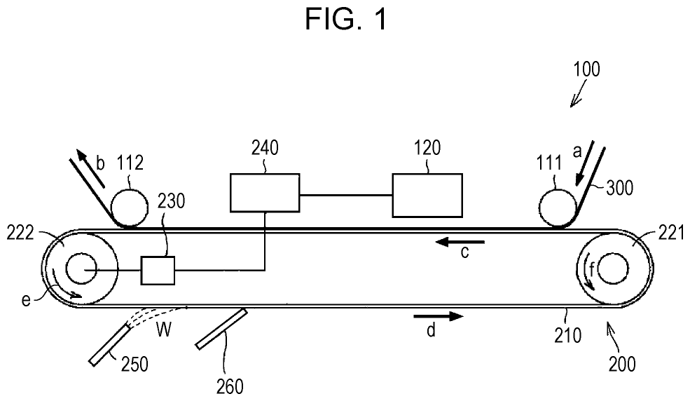

In addition, when the adhesive layer is formed on the cloth transport member of the ink jet printing apparatus by application of the adhesive, and when the cloth is transported while being in close contact with the adhesive layer, another problem may arise. That is, while having an appropriate adhesion to be adhered to the cloth and to be peeled away therefrom, the adhesive layer is required to have a durability, a water resistance, and a mechanical strength to withstand against water washing and/or brushing which is performed to remove lint and inks adhered to the adhesive layer. However, while being used, an adhesive layer formed from a water-based adhesive is liable to have an inferior water resistance such that whitening occurs and/or to have an inferior mechanical strength such that peeling occurs. In addition, as shown in FIG. 1, when the cloth transport member on which the water-based adhesive is applied is used, the adhesive layer formed therefrom cannot maintain the adhesiveness as the transport length of the cloth is increased, and hence, the durability as the adhesive also tends to be degraded. Hence, when being formed from the water-based adhesive, an adhesive layer excellent not only in water resistance but also in adhesion and mechanical strength is difficult to form.

In addition, in general, the adhesiveness of the adhesive is not a little influenced by the temperature. When the adhesiveness is degraded or improved, the transport property of the cloth is degraded, and for example, the cloth may be unfavorably clogged in a printing apparatus. Hence, the adhesive to be used for the ink jet printing is required to maintain the adhesiveness in a wide temperature range.

In order to overcome the problem described above, the aqueous adhesive composition of this embodiment contains a predetermined (meth)acrylic-based resin, a pH adjuster, and water. Accordingly, while the water resistance and the mechanical strength are improved, in a wide temperature range, the adhesiveness can be maintained. Hereinafter, the individual components contained in the aqueous adhesive composition will be described in detail.

### 1.1. (Meth)Acrylic-Based Resin

Since the predetermined (meth)acrylic-based resin is contained, the adhesion and the water resistance of the adhesive layer formed on the cloth transport member are not only improved, but the adhesiveness can also be maintained in a wide temperature range. The (meth)acrylic-based resin may be a water-soluble resin or may be in the form of resin emulsion in which the resin is dispersed in a water-based solvent. Those materials are also collectively called a (meth)acrylic-based resin in this embodiment. Since the (meth)acrylic-based resin is used, the environmental loads caused by organic solvents can be reduced, and in addition, a peelability of the cloth from the adhesive layer also tends to be further improved.

The (meth)acrylic-based resin includes, as the constituent units, at least four types of (meth)acrylate units A and at least one type of (meth)acrylic acid unit B.

Although being not particularly limited, for example, the (meth)acrylate unit A preferably includes a constituent unit derived from at least one monomer selected from the group consisting of methyl methacrylate (MMA), ethyl methacrylate (EMA), butyl methacrylate (BMA), butyl acrylate (BA), and 2-ethylhexyl acrylate (2EHA). Since the (meth)acrylate unit A as described above is used, the adhesion durability, the water resistance, and the mechanical strength of the adhesive layer formed on the cloth transport member are improved, and in addition, the adhesiveness also tends to be further maintained in a wide temperature range.

In addition, among those mentioned above, the at least four types of (meth)acrylate units A include a constituent unit derived from butyl acrylate and a constituent unit derived from a butyl methacrylate, and among the constituent units described above, one of the constituent unit derived from butyl acrylate and the constituent unit derived from butyl methacrylate preferably has a highest content, and the other preferably has a second highest content. In addition, the constituent unit derived from butyl acrylate may be the constituent unit having a highest content, or the constituent unit derived from butyl methacrylate may be the constituent unit having a highest content. Accordingly, the adhesion durability, the water resistance, and the mechanical strength of the adhesive layer formed on the cloth transport member are further improved, and in addition, the adhesiveness tends to be further maintained in a wide temperature range.

The content of the constituent unit derived from butyl acrylate with respect to a total mass of the (meth)acrylic-based resin is preferably 20 to 35 percent by mass, 15 to 40 percent by mass, 10 to 45 percent by mass, or 5 to 50 percent by mass. Accordingly, the adhesion durability, the water resistance, the mechanical strength of the adhesive layer formed on the cloth transport member are further improved, and in addition, the adhesiveness tends to be further maintained in a wide temperature range.

The content of the constituent unit derived from butyl methacrylate with respect to the total mass of the (meth)acrylic-based resin is preferably 45 to 55 percent by mass, 40 to 57.5 percent by mass, 35 to 60 percent by mass, 30 to 62.5 percent by mass, 25 to 65 percent by mass, or 20 to 67.5 percent by mass. Accordingly, the adhesion durability, the water resistance, and the mechanical strength of the adhesive layer formed on the cloth transport member are further improved, and in addition, the adhesiveness tends to be further maintained in a wide temperature range.

A content of the (meth)acrylate unit A with respect to the total mass of the (meth)acrylic-based resin is preferably 97 to 99.9 percent by mass, 97.5 to 99.7 percent by mass, or 98 to 99.5 percent by mass. Since the content of the (meth)acrylate unit A is 97 percent by mass or more, the water resistance and the mechanical strength tend to be further improved. In addition, since the content of the (meth)acrylate unit A is 99.9 percent by mass or less, the adhesion durability of the adhesive layer formed on the cloth transport member tends to be further improved.

The (meth)acrylate unit A preferably includes at least two types of (meth)acrylate units A1 having a glass transition temperature of 15° C. or more and at least two types of (meth)acrylate units A2 having a glass transition temperature of −50° C. or less. As described above, since the (meth)acrylate unit A1 having a relatively high glass transition temperature and the (meth)acrylate unit A2 having a relatively low glass transition temperature are included, the adhesion durability, the water resistance, and the mechanical strength of the adhesive layer formed on the cloth transport member are further improved, and in addition, the adhesiveness tends to be further maintained in a wide temperature range.

Although the (meth)acrylate unit A1 is not particularly limited, for example, butyl acrylate (BA) or 2-ethylhexyl acrylate (2EHA) may be mentioned. In addition, a content of the (meth)acrylate unit A1 with respect to the total mass of the (meth)acrylic-based resin is preferably 35 to 75 percent by mass, 45 to 70 percent by mass, or 50 to 65 percent by mass. Since the content of the (meth)acrylate unit A1 is in the range described above, the adhesion durability, the water resistance, and the mechanical strength of the adhesive layer formed on the cloth transport member are further improved, and in addition, the adhesiveness tends to be further maintained in a wide temperature range.

Although the (meth)acrylate unit A2 is not particularly limited, for example, methyl methacrylate (MMA), ethyl methacrylate (EMA), or butyl methacrylate (BMA) may be mentioned. In addition, a content of the (meth)acrylate unit A2 with respect to the total mass of the (meth)acrylic-based resin is preferably 25 to 65 percent by mass, 30 to 55 percent by mass, or 35 to 50 percent by mass. Since the content of the (meth)acrylate unit A2 is in the range described above, the adhesion durability, the water resistance, and the mechanical strength of the adhesive layer formed on the cloth transport member are further improved, and in addition, the adhesiveness tends to be further maintained in a wide temperature range.

Although the (meth)acrylic acid unit B is not particularly limited, for example, acrylic acid (AA) or methacrylic acid (MA) may be mentioned.

A content of the (meth)acrylic acid unit B with respect to the total mass of the (meth)acrylic-based resin is preferably 0.1 to 3.0 percent by mass, 0.3 to 2.5 percent by mass, or 0.5 to 2.0 percent by mass. Since the content of the (meth)acrylic acid unit B is 0.1 percent by mass or more, the adhesion durability of the adhesive layer formed on the cloth transport member is further improved. In addition, since the content of the (meth)acrylic acid unit B is 3.0 percent by mass or less, the water resistance and the mechanical strength tend to be further improved.

A difference in glass transition temperature between the maximum value and the minimum value among the homopolymers formed from the respective constituent units is preferably 170° C. or more, 170° C. to 250° C., or 172° C. to 225° C. Since the difference in glass transition temperature between the maximum value and the minimum value among the homopolymers formed from the respective constituent units is 170° C. or more, the adhesion, the adhesion durability, and the mechanical strength of the adhesive layer formed on the cloth transport member are further improved, and in addition, the adhesiveness tends to be further maintained in a wide temperature range.

For example, a (meth)acrylic-based resin is assumed which includes as the (meth)acrylate unit A, methyl methacrylate (MMA), ethyl methacrylate (EMA), butyl methacrylate (BMA), butyl acrylate (BA), and 2-ethylhexyl acrylate (2EHA) and which includes acrylic acid (AA) as the (meth)acrylic acid unit B. In this case, acrylic acid (AA) is a monomer, the homopolymer of which has a maximum glass transition temperature of 106° C. In addition, 2-ethylhexyl acrylate (2EHA) is a monomer, the homopolymer of which has a minimum glass transition temperature of −70° C. Hence, in the case described above, the difference in glass transition temperature between the maximum value and the minimum value among the homopolymers is 176° C.

The glass transition temperature of the (meth)acrylic-based resin is −25° C. to −8° C., and preferably −21° C. to −9° C. or −18° C. to −10° C. Since the glass transition temperature of the (meth)acrylic-based resin is −25° C. or more, the adhesion durability of the adhesive layer formed on the cloth transport member tends to be further improved. In addition, since the glass transition temperature of the (meth)acrylic-based resin is −8° C. or less, the adhesiveness tends to be further maintained in a wide temperature range.

In this embodiment, the glass transition temperature can be measured by a known method using a differential scanning calorimetry (DSC) analysis. In addition, the glass transition temperature of the (meth)acrylic-based resin can be adjusted by glass transition temperatures of homopolymers formed from polymerizable compounds to be used and content mass rates of the above polymerizable compounds.

A content of the (meth)acrylic-based resin with respect to the total mass of the aqueous adhesive composition is preferably 30 to 70 percent by mass, 35 to 65 percent by mass, 40 to 60 percent by mass, or 45 to 55 percent by mass. Since the content of the (meth)acrylic-based resin is in the range described above, the adhesion durability, the water resistance, and the mechanical strength of the adhesive layer formed on the cloth transport member are further improved, and in addition, the adhesiveness tends to be further maintained in a wide temperature range. In addition, the content with respect to the total mass of the aqueous adhesive composition is on a solid content basis.

In addition, the aqueous adhesive composition may also contain a resin other than the (meth)acrylic-based resin described above. Although the resin described above is not particularly limited, for example, an urethane resin may be mentioned.

### 1.2. pH Adjuster

Although the pH adjuster is not particularly limited, for example, there may be mentioned an inorganic acid (such as sulfuric acid, hydrochloric acid, or nitric acid), an inorganic base (such as lithium hydroxide, sodium hydroxide, potassium hydroxide, ammonia, or an ammonium salt), an organic base (such as triethanolamine, diethanolamine, monoethanolamine, or tripropanolamine), or an organic acid (such as adipic acid, citric acid, or succinic acid).

Among those mentioned above, ammonia or an ammonium salt is preferable. Since the pH adjuster as described above is used, ammonia is evaporated when the adhesive layer is formed, and the (meth)acrylic-based resin particles are easily adhered to each other, so that a coating film into which water is not likely to intrude is formed. Hence, the adhesion durability and the water resistance of the adhesive layer formed on the cloth transport member are further improved, and in addition, the adhesiveness tends to be further maintained in a wide temperature range.

In addition, when the surface of the cloth transport member includes an urethane resin, by the function of ammonia or an ammonium salt, the adhesiveness between the (meth)acrylic-based resin and the urethane resin is further improved, and the mechanical strength also tends to be further improved.

A content of the pH adjuster with respect to the total mass of the aqueous adhesive composition is preferably 0.05 to 1.50 percent by mass, 0.10 to 1.00 percent by mass, 0.15 to 0.50 percent by mass, or 0.20 to 0.30 percent by mass. Since the content of the pH adjuster is in the range described above, the adhesion durability and the water resistance of the adhesive layer formed on the cloth transport member are improved, and in addition, the adhesiveness tends to be further maintained in a wide temperature range.

### 1.3. Water

A content of the water with respect to the total mass of the aqueous adhesive composition is preferably 30 to 80 percent by mass, 35 to 70 percent by mass, or 40 to 60 percent by mass.

### 1.4. Surfactant

The aqueous adhesive composition may also contain a surfactant. Although the surfactant is not particularly limited, for example, there may be mentioned an anionic surfactant, a nonionic surfactant, or a cationic surfactant.

As the anionic surfactant, for example, there may be mentioned an alkyl sulfate salt, such as an alkylsulfocarboxylic acid salt, an alkyldiphenyl ether disulfonate salt, an α-olefinsulfonic acid salt, a polyoxyethylene alkyl ether acetic acid salt, N-acylamino acid or a salt thereof, an N-acylmethyltaurine salt, ammonium lauryl sulfate, or sodium lauryl sulfate; an alkylsulfate polyoxyalkyl ether sulfuric acid salt, an alkylsulfate polyoxyethylene alkyl ether phosphoric acid salt, a rosin acid soap, a castor oil sulfuric acid ester salt, a lauryl alcohol sulfuric acid ester salt, an alkylphenol-type phosphoric acid ester, an alkyl-type phosphoric acid ester, an alkylarylsulfonic acid salt, a diethylsulfosuccinic acid salt, a diethylhexylsulfosuccinic acid salt, or a dioctylsulfosuccinic acid salt. A commercial product of the anionic surfactant is not particularly limited, and for example, there may be mentioned Emal 2FG, Emal TD, or Latemul AD25 (trade name, manufactured by Kao Corporation); or Monogen Y100, Monogen Y500T, or Hitenol LA12 (trade name, manufactured by DKS Co., Ltd.).

As the nonionic surfactant, for example, there may be mentioned an acetylene glycol-based surfactant, a silicone-based surfactant, a polyoxyethylene alkyl ether, a polyoxyethylene alkyl phenyl ether, a polyoxyethylene fatty acid ester, a polyoxyethylene hydrogenated castor oil, a propylene glycol fatty acid ester, a glycerin fatty acid ester, a polyglycerin fatty acid ester, a sorbitan fatty acid ester, a sucrose fatty acid ester, an alkyl polyglycoside, an alkyl diethanolamide, or an alkylamine oxide. A commercial product of the nonionic surfactant is not particularly limited, and for example, there may be mentioned Emulgen 123P, 430, or 1108 (trade name, manufactured by Kao Corporation); Newcol 1006, 1008, or 1020 (trade name, manufactured by Nippon Nyukazai Co., Ltd.); or Noigen DL-0415, ET-116B, ET-106A, DH-0300, YX-400, or EA-160 (trade name, manufactured by DKS Co., Ltd.).

As the cationic surfactant, for example, there may be mentioned an alkylamine salt, a fatty acid amideamine salt, a monoalkyl type quaternary ammonium salt, a dialkyl type quaternary ammonium salt, a trialkyl type quaternary ammonium salt, a benzalkonium type quaternary ammonium salt, benzethonium chloride, or an alkyl pyridinium salt.

In this embodiment, among those mentioned above, the nonionic surfactant is preferable, and in more particular, an alkyl ether-based nonionic surfactant is preferable. The nonionic surfactant is more preferably used in combination with an anionic surfactant. When the surfactants as described above are used, the durability and the water resistance tend to be maintained.

A content of the surfactant with respect to the total mass of the aqueous adhesive composition is preferably 1 to 7 percent by mass, 2 to 6 percent by mass, or 3 to 5 percent by mass.

### 1.5. Adhesiveness Imparting Agent

The aqueous adhesive composition preferably contains no adhesiveness imparting agent or a small amount thereof. When the aqueous adhesive composition contains no adhesiveness imparting agent or a small amount thereof, the adhesion of the adhesive layer and an effect of suppressing a decrease of adhesion during brushing tend to be sustained. As the adhesiveness imparting agent as described above, for example, a rosin-based compound, a terpene-based compound, or a hydrocarbon resin may be typically mentioned. In more particular, for example, there may be mentioned a rosin-based compound, such as a natural rosin, a modified rosin, a glycerol ester of a natural rosin, a glycerol ester of a modified rosin, a pentaerythritol ester of a natural rosin, or a pentaerythritol ester of a modified rosin; a terpene-based compound, such as a copolymer of natural terpenes, a three-dimensional polymer of natural terpenes, an aromatic modified terpene resin, a hydrogenated derivative of an aromatic modified terpene resin, a terpene phenol resin, or a terpene resin (such as a monoterpene, a diterpene, a triterpene, or a polyterpene); or a hydrocarbon resin, such as an aliphatic petroleum hydrocarbon resin (C5-based resin), a hydrogenated derivative of an aliphatic petroleum hydrocarbon resin, an aromatic petroleum hydrocarbon resin (C9-based resin), such as a styrene oligomer, or a hydrogenated derivative of an aromatic petroleum hydrocarbon resin.

Although the adhesiveness imparting agent is preferably not contained, when the adhesiveness imparting agent is contained, a content thereof with respect to the total mass of the aqueous adhesive composition is preferably 5 percent by mass or less, 4 percent by mass or less, 3 percent by mass or less, 2 percent by mass or less, or 1 percent by mass or less. Since the content of the adhesiveness imparting agent is in the range described above, the adhesion of an adhesive layer to be obtained and the effect of suppressing a decrease of adhesion during brushing tend to be sustained. From the point similar to that described above, a total content of the compounds selected from the group consisting of the rosin-based compound, the terpene-based compound, and the hydrocarbon resin is also preferably set in the range similar to that described above.

### 1.6. Organic Solvent

In order to reduce the influences on the environmental loads and human bodies, the aqueous adhesive composition of this embodiment preferably contains no organic solvents which are subject to the Ordinance On Prevention of Organic Solvent Poisoning (hereinafter, referred to as the “Organic Solvent Ordinance”), defined by Ministry of Health, Labor and Welfare, Japan and more preferably contains no organic solvents which are not subject to the Organic Solvent Ordinance. In addition, when an organic solvent is contained, the content thereof with respect to the total mass of the aqueous adhesive composition is preferably 5.0 percent by mass or less, 2.5 percent by mass or less, or 1.0 percent by mass or less. Accordingly, since the environmental loads can be reduced, and VOC (volatile organic compounds) generated when the aqueous adhesive composition is used can also be reduced, the working conditions tend to be further improved.

### 1.7. Colorant

The aqueous adhesive composition of this embodiment preferably contains no colorants. In addition, when a colorant is contained, the content thereof with respect to the total mass of the aqueous adhesive composition is preferably 1.0 percent by mass or less, 0.5 percent by mass or less, or 0.3 percent by mass or less. Accordingly, the aqueous adhesive composition of this embodiment can be clearly discriminated from a composition, such as an ink composition, a printing paste, or a paint, which aims at coloration.

### 2. Adhesiveness Imparting Method

An adhesiveness imparting method of this embodiment includes a step of adhering the aqueous adhesive composition described above to a surface of a cloth transport member of an ink jet printing apparatus to form an adhesive layer.

The step to form the adhesive layer is a step in which the aqueous adhesive composition described above is adhered to the surface of the cloth transport member to form the adhesive layer. A method to adhere the aqueous adhesive composition to the cloth transport member is not particularly limited, and the aqueous adhesive composition may be uniformly applied over the entire surface of the cloth transport member using a blade or the like or may also be applied so as to form a predetermined pattern on a part of the surface of the cloth transport member.

In addition, in the adhesive layer forming step, the adhesive layer may be formed by drying the aqueous adhesive composition. A drying temperature is preferably 10° C. to 60° C. or 20° C. to 40° C. In addition, a drying time is preferably 1 to 24 hours or 2 to 8 hours. Accordingly, the water resistance and the mechanical strength of an adhesive layer to be obtained tend to be further improved.

### 3. Ink Jet Printing Apparatus

An ink jet printing apparatus of this embodiment includes a transport mechanism in which a cloth is adhered to an adhesive layer and is transported, the adhesive layer being formed of the aqueous adhesive composition described above and being provided on a surface of a cloth transport member; a recording portion to perform printing recording using an ink jet head on the cloth adhered to the adhesive layer; and a washing portion to wash the adhesive layer from which the cloth is peeled away after the printing recording is performed.

With reference to FIG. 1, an ink jet printing apparatus 100 of this embodiment will be described. FIG. 1 is an entire structural view of the ink jet printing apparatus 100 which includes a transport device 200 of this embodiment. In FIG. 1, arrows a and b each indicate a transport direction of a recording medium 300. Arrows c and d each indicate a moving direction of a cloth transport member 210. Arrows e and f indicate rotation directions of transport rollers 222 and 221, respectively.

The ink jet printing apparatus 100 may include the transport device 200 in which a recording medium is adhered to a surface of the cloth transport member 210 and is transported, recording medium transport rollers 111 and 112, and a recording portion 120. The recording medium 300 coming along the direction a is pressed to the cloth transport member 210 by the recording medium transport roller 111 and is then adhered to the surface of the cloth transport member 210.

While being adhered to the surface of the cloth transport member 210, the recording medium 300 is transported under the recording portion 120 by the transport device 200, and recording is then performed on the recording medium 300 by the recording portion 120. In addition, subsequently, at the recording medium transport roller 112, the recording medium 300 is peeled away from the cloth transport member 210.

The recording portion 120 may eject an ink composition or the like by an ink jet method. In this embodiment, although the case in which an ink jet type head is used for the recording portion 120, and printing is performed on a textile cloth functioning as the recording medium 300 is assumed, the configuration is not limited thereto.

The transport device 200 may include a pair of the transport rollers 221 and 222, the cloth transport member 210, a drive motor 230, a control device 240, a washing portion 250, and a removing member 260.

The transport rollers 221 and 222 are each a roller to transport the cloth transport member 210 in a predetermined direction. In addition, the cloth transport member 210 may be a belt member having a surface on which the adhesive layer is provided and is stretched around the transport rollers 221 and 222. Since the transport rollers 221 and 222 are rotated by the drive motor 230, the cloth transport member 210 transports the recording medium in the arrow c direction. The control device 240 may control at least one of the transport device 200 and the ink jet printing apparatus 100.

The washing portion 250 washes the surface of the cloth transport member 210 from which the recording medium 300 is peeled away. By the washing portion 250, components of the recording medium 300 and printing colorants which are adhered to the cloth transport member 210 during the printing are washed out. In the washing portion 250, a pump (not shown), a sprinkler port, and a sprinkler pipe may be provided.

The removing member 260 removes water adhered to the cloth transport member 210 by the washing portion 250. The removing member 260 is not particularly limited, and for example, a blade may be mentioned. As a blade material, an elastic material is preferable. Furthermore, in view of abrasion resistance, a polyurethane is preferable. Although a contact section in contact with the cloth transport member 210 may have a rectangular cross-section, a contact section having a diagonally truncated shape may also be used.

As the cloth transport member 210, an elastic material is preferable. A heater (not shown) to warm the cloth transport member 210 may also be provided. In the step of washing the cloth transport member 210, for example, a water receiver (not shown) to receive washing water and a brush (not shown) or a sponge (not shown) to clean the cloth transport member 210 may also be used.

As the recording medium 300, for example, there may be mentioned a cloth formed from natural fibers of silk, cotton, or wool, or synthetic fibers of a nylon, a polyester, or a rayon. In addition, as the cloth, for example, a woven fabric, a knitted fabric, or a non-woven cloth may also be used.

### 4. Cloth Transport Member of Ink Jet Printing Apparatus

A cloth transport member of the ink jet printing apparatus of this embodiment has a surface on which an adhesive layer derived from the aqueous adhesive composition described above is provided. Although the cloth transport member is not particularly limited, for example, an elastic material is preferable, and an urethane resin is particularly preferable. Since the aqueous adhesive composition described above is used for the cloth transport member as described above, the adhesiveness between the adhesive layer and the cloth transport member is further improved, and the water resistance is also improved.

### 5. Ink Jet Printing Method

An ink jet printing method of this embodiment includes a transport step in which a cloth is adhered to an adhesive layer and is transported, the adhesive layer being formed from the aqueous adhesive composition described above and being provided on a surface of a cloth transport member of an ink jet printing apparatus; a recording step of performing printing recording using an ink jet head on the cloth adhered to the adhesive layer; and after the printing recording is performed, a washing step of washing the adhesive layer from which the cloth is peeled away.

### 5.1. Transport Step

The transport step is a step in which a cloth is adhered to an adhesive layer and is transported, the adhesive layer being formed from the aqueous adhesive composition described above and being provided on a surface of a cloth transport member of an ink jet printing apparatus. An adhering method is not particularly limited, and as shown in FIG. 1, a method in which the cloth and the adhesive layer are pressed and adhered to each other using the transport roller may be mentioned.

### 5.2. Recording Step

The recording step is a step of performing printing recording using an ink jet head on the cloth adhered to the adhesive layer. In the recording step, the cloth is transported while being in close contact with the cloth transport member with the adhesive layer provided therebetween, and in this transport process, an ink is ejected from the recording portion 120 and is adhered to the cloth. Subsequently, the cloth to which the ink is adhered may be recovered after being peeled away from the adhesive layer.

### 5.3. Washing Step

The washing step is a step of washing the adhesive layer from which the cloth is peeled away after the printing recording is performed. By this step, trash, such as lint, derived from the cloth and adhered to the surface of the adhesive layer in the recording step can be removed therefrom.

### Examples

Hereinafter, the present disclosure will be described in more detail with reference to Examples and Comparative Examples. The present disclosure is not limited at all to the following Examples.

### 1. Manufacturing of Aqueous Adhesive Composition

After 114 g of ion exchange water was added to a reaction vessel equipped with a stirrer, a reflux condenser, a thermometer, a nitrogen introduction tube, and a dripping funnel, the temperature was increased to 82° C. Subsequently, 498 g (in total) of monomers which were measured to have respective composition rates shown in the following Table 1, 79 g of ion exchange water, 34 g of Emulgen 123P (surfactant, trade name, manufactured by Kao Corporation), and 34 g of Hitenol LA 12 (surfactant, trade name, manufactured by DKS Co., Ltd.) were added to the reaction vessel and then mixed and stirred. To the solution thus homogenized, 249 g of an aqueous solution of ammonium persulfate at a concentration of 2 percent by mass functioning as a polymerization initiator was added over 1.5 hours at 82° C.

After all the types of materials described above were added, the temperature was maintained for 1 hour and was then decreased. Subsequently, ion exchange water was added, and in addition, as a pH adjuster, ammonia water was also charged. Next, coarse and large particles were removed by filtration using a 150-mesh nylon filter, and as a result, an aqueous adhesive composition containing a (meth)acrylic-based resin having the composition shown in Table 1 was obtained.

In addition, the individual monomers used as the constituent units of the (meth)acrylic-based resin described in Table 1 are as shown below. The temperature shown in the parentheses indicates a glass transition temperature of a homopolymer. In Table 1, the parts by weight of the constituent units are described so that the total thereof is 100 parts by weight. In addition, a glass transition temperature Tg of the (meth)acrylic-based resin was measured in accordance with JIS K7121 using a differential scanning calorimeter (DSC).
2EHA: 2-ethylhexyl acrylate (−70° C.)
BA: butyl acrylate (−55° C.)
BMA: butyl methacrylate (20° C.)
EMA: ethyl methacrylate (65° C.)
MMA: methyl methacrylate (105° C.)
AA: acrylic acid (106° C.)
MAA: methacrylic acid (130° C.)

### 2. Evaluation Method

### 2.1. Adhesiveness of Adhesive Layer

A transport belt having a surface formed of an urethane material was mounted in a digital printing machine ML-8000 manufactured by EPSON. The aqueous adhesive composition prepared as described above was applied to the transport belt and then dried, so that an adhesive layer was formed. In addition, under respective conditions at test environment temperatures of 5° C., 20° C., and 35° C., the transport belt was transported as shown in FIG. 1 such that a cloth was adhered to the transport belt, was then transported, and was finally peeled away therefrom.

As the cloth, two types of cloths were used for evaluation of the adhesiveness. One type of cloth was formed from a thin see-through organdy fabric made in England as a cloth which was not easily adhered and had a weak tensile strength, and the other type of cloth was formed from 100-% cotton fabric which is easily adhered.

When the cloth was transported 10 m and 10,000 m, the adhesiveness was respectively evaluated based on the following evaluation criteria. The 10,000-m transport was performed to evaluate the durability.

### Evaluation Criteria

A: transport is performed without peeling.
B: although partial peeling is observed during transport, transport is performed.
C. since peeling is generated during transport so that transport is required to be stopped, transport is not practically performed.

### 2.2. Mechanical Strength of Adhesive Layer

By the use of the digital printing machine ML-8000 described above, as shown in FIG. 1, brush cleaning with water was performed. When the cloth was transported 10 m and 10,000 m, respectively, the mechanical strength was evaluated based on the following evaluation criteria.

### Evaluation Criteria

A: no peeling of adhesive layer from cloth transport member (transport belt) is observed.
C: peeling of adhesive layer from cloth transport member (transport belt) is observed.

### 2.2. Water Resistance of Adhesive Layer

By the use of the digital printing machine ML-8000 described above, as shown in FIG. 1, brush cleaning with water was performed. When the cloth was transported 10 m and 10,000 m, respectively, the water resistance was evaluated based on the following evaluation criteria. In addition, a part of the adhesive layer at which whitening was observed by visual inspection had an inferior adhesion.

### Evaluation Criteria

A: adhesive layer is transparent.
B: adhesive layer is partially whitened.
C: adhesive layer is entirely whitened.

### 3. Evaluation Result

In Table 1, the compositions and the evaluation results of the aqueous adhesive compositions used in Examples and Comparative Examples are shown. From Table 1, it is found that when an aqueous adhesive composition to form an adhesive layer on a surface of a cloth transport member of an ink jet printing apparatus contains a predetermined (meth)acrylic-based resin, a pH adjuster, and water, the adhesion durability, the water resistance, and the mechanical strength of the adhesive layer formed on the cloth transport member are further improved, and in addition, the adhesiveness is further maintained in a wide temperature range.

In addition, as the transport belt described above, a transport belt having a surface formed of a polyester resin instead of using the urethane resin was used, and a test similar to that of Example 1 was performed. As a result, it was confirmed that when the urethane resin was used as the material of the transport belt, compared to the case using the polyester resin, the adhesion durability, the water resistance, and the mechanical strength of the adhesive layer are high, and a temperature range in which the adhesion is appropriately obtained can be increased. Hence, when a cloth transport member including an urethane resin is used, the aqueous adhesive composition of this embodiment can be preferably used.

What is claimed is:

1. An aqueous adhesive composition to form an adhesive layer on a surface of a cloth transport member of an ink jet printing apparatus, the aqueous adhesive composition comprising:
a (meth)acrylic-based resin;
a pH adjuster; and
water,
wherein the (meth)acrylic-based resin includes, as constituent units, at least four types of (meth)acrylate units A and at least one type of (meth)acrylic acid unit B,
the (meth)acrylic-based resin has a glass transition temperature of −25° C. to −8° C., and
a difference in glass transition temperature between the maximum value and the minimum value among homopolymers formed from the respective constituent units is 170° C. or more.

2. The aqueous adhesive composition according to claim 1,
wherein a content of the (meth)acrylic acid unit B is 0.1 to 3.0 percent by mass with respect to a total mass of the (meth)acrylic-based resin.

3. The aqueous adhesive composition according to claim 1,
wherein the at least four types of (meth)acrylate units A include at least two types of units A1 derived from (meth)acrylates, the homopolymers of which each have a glass transition temperatures of 15° C. or more, and at least two types of units A2 derived from (meth)acrylates, the homopolymers of which each have a glass transition temperatures of −50° C. or less.

4. The aqueous adhesive composition according to claim 1,
wherein the at least four types of (meth)acrylate units A include a constituent unit derived from at least one monomer selected from the group consisting of 2-ethylhexyl acrylate, butyl acrylate, butyl methacrylate, ethyl methacrylate, and methyl methacrylate.

5. The aqueous adhesive composition according to claim 1,
wherein the at least four types of (meth)acrylate units A include a constituent unit derived from butyl acrylate and a constituent unit derived from butyl methacrylate, and
one of the constituent unit derived from butyl acrylate and the constituent unit derived from butyl methacrylate has a highest content, and the other has a second highest content.

6. The aqueous adhesive composition according to claim 1,
wherein the pH adjuster includes ammonia or an ammonium salt.

7. The aqueous adhesive composition according to claim 1,
wherein the cloth transport member includes an urethane resin.

8. An adhesiveness imparting method comprising:
adhering the aqueous adhesive composition according to claim 1 to a surface of a cloth transport member of an ink jet printing apparatus to form an adhesive layer.

9. An ink jet printing apparatus comprising:
a transport mechanism in which a cloth is adhered to an adhesive layer and is transported, the adhesive layer being formed of the aqueous adhesive composition according to claim 1 and being provided on a surface of a cloth transport member;
a recording portion to perform printing recording using an ink jet head on the cloth adhered to the adhesive layer; and
a washing portion to wash the adhesive layer from which the cloth is peeled away after the printing recording is performed.

10. A cloth transport member of an ink jet printing apparatus, having a surface on which an adhesive layer derived from the aqueous adhesive composition according claim 1 is provided.

11. An ink jet printing method comprising:
a transport step in which a cloth is adhered to an adhesive layer and is transported, the adhesive layer being formed from the aqueous adhesive composition according to claim 1 and being provided on a surface of a cloth transport member of an ink jet printing apparatus;
a recording step of performing printing recording using an ink jet head on the cloth adhered to the adhesive layer; and
after the printing recording is performed, a washing step of washing the adhesive layer from which the cloth is peeled away.
